(19) United States
(12) Patent Application Publication
(10) Pub. No.: US 2024/0016141 A1
(43) Pub. Date: Jan. 18, 2024

(54) BUGLE TUBE

(71) Applicant: Slayer Duck Calls, LLC, Eagle, ID (US)

(72) Inventor: William L. Ayer, III, Eage, ID (US)

(21) Appl. No.: 18/352,663

(22) Filed: Jul. 14, 2023

Related U.S. Application Data
(60) Provisional application No. 63/368,415, filed on Jul. 14, 2022.

(51) Int. Cl. A01M 31/00

(52) U.S. Cl. CPC A01M 31/004

(57) ABSTRACT

An improved bugle call having an improved mouthpiece. The mouthpiece is constructed of an acrylic and configured to optimize back pressure blown into the mouthpiece. The acrylic construction significantly improves the harmonics of the bugle tube, allowing the user to simulate the sound of a bull elk bugling. The bugle tube is utilized with a reed to produce sound. The reed is preferably positioned in the user's mouth and operated as what is traditionally called an external reed call. The use of acrylic for the mouthpiece has produced a dramatically improved sound compared to traditional, known bugle tubes.

### CROSS-REFERENCE TO RELATED APPLICATIONS

This application claims the benefit of U.S. Provisional Application No. 63/368,415, filed Jul. 14, 2022, the disclosure of which is incorporated by reference.

### TECHNICAL FIELD

The disclosure generally relates to the field of game calls. Particularly the embodiments relate to improved bugle tube styled game calls.

### BACKGROUND

Hunters, photographers and competitive game callers often use a reed in combination with an air production to force air over the reed. Air traveling over the reed causes the reed to resonate, producing a sound that imitates an animal, such as an elk. These reeds can be made either integral to a call or can be utilized by positioning a typically rounded reed into the user's mouth and blowing air across the reed. Reeds that are utilized within a user's mouth are called internal reeds whereas reeds attached to a call or otherwise positioned outside of the user's mouth are typically called external reed calls. External reed calls can be integrated upstream from a tube that enhances the sound. The external reed calls can be utilized either with a manual device that blows air through or utilizing a user's mouth to blow air through the call.

A bugle tube is used for elk calling, they imitate the sounds of male (or bull) elk. Bugle tubes are utilized downstream of the reed. The tube allows for the amplification and enhancement of the sound to imitate the bugle of the bull elk during the rut. Typically these bugle tubes are made of plastic and often have a mechanical or otherwise not fully realistic sound produced by the limitations of their construction. What is needed is an improved construction of an Elk bugle tube to produce more natural, lifelike sounds.

### SUMMARY

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

The disclosed invention relates to game calls, in particular, bugle tube styled game calls. In a preferred embodiment, the disclosed invention will create realistic guttural and nasal sounds that echo those of a mature bull. The design allows users to use less air while simultaneously achieving louder sounds and higher octaves. A preferred embodiment of the disclosed invention will enable users to have much more control of the reed of the call, which combined with the acrylic material which the neck or throat of the call is made from, allows users to create realistic, loud sounds. A user draws air against the rifling in the acrylic of the preferred embodiment and chuckling, grunting, or panting which produces a realistic bull elk diaphragm sounds. In a preferred embodiment, the acrylic of the bugle tube will allow users to scale up octaves and eliminate plastic sounds that are typical in previous designs of game calls.

The call is constructed such that the user creates back pressure in front of the reed by a venturi, allowing the user to have very specific control over the sound. In a preferred embodiment, the dynamics of the venturi are determined by the critical dimensions (namely the inside diameter, outside diameter, and length) of the mouth piece. The hard, acrylic material utilized in a preferred embodiment of this invention allows the bugle to absorb minimal sound in the handle, giving way for a much more direct and energetic projection of sound from the reed.

What is disclosed is a game call having an elongate acrylic mouthpiece. The elongate mouthpiece has a mouthpiece wall having a first end and a second end. The mouthpiece wall has an inner surface and an outer surface. The first end defines a first mouthpiece end aperture and the second end defines a second mouthpiece end aperture. The mouthpiece wall inner surface defines an air flowpath from the first mouthpiece end aperture through the mouthpiece and out said second aperture. The first mouthpiece end aperture having a greater circumference than said second mouthpiece end aperture.

The mouthpiece wall inner surface has a tapered section extending inward from said first mouthpiece end aperture to a cylindrical section. The tapered section is configured to provide backpressure on air blown by a user into the first end aperture. The cylindrical section comprises a generally uniform circumference and extends to the second mouthpiece end aperture. The elongate mouthpiece is formed of an acrylic, providing enhanced acoustical properties to the bugle tube.

A bugle wall is connected to the second end of said mouthpiece. The bugle wall defines a resonance chamber. The bugle wall has a bugle wall circumference greater than the circumference of said first mouthpiece end aperture.

In a preferred embodiment, the mouthpiece length is approximately 6 inches. Preferably the taper section extends for approximately 1.75 inches of the 6 inches. Alternate measurements can be used, such as a ration of 25 to 35% of the total length of the mouthpiece, or a narrower range of 28 to 32%, while 1.75 inches is approximately 29% of the total length of the mouthpiece. Preferably the bugle wall is seated against a bugle seat of the outer surface of the mouthpiece. The bugle seat is approximately an inch from said second mouthpiece end. The bugle wall is preferably made of plastic.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature

In the following description and in the figures, like elements are identified with like reference numerals. The use of “e.g.,” “etc.,” and “or” indicates non-exclusive alternatives without limitation unless otherwise noted. The use of “including” means “including, but not limited to,” unless otherwise noted.

### BRIEF DESCRIPTION OF FIGURES

FIG. 1 illustrates a diagram of the preferred embodiment of the invention being a mouthpiece attached to a bugle tube.

FIG. 2 illustrates a preferred embodiment of a mouthpiece.

FIG. 3 illustrates a second view of the mouthpiece of FIG. 2.

FIG. 4 illustrates the front view of a mouthpiece, looking directly down the shaft.

FIG. 5 illustrates a side view of the mouthpiece of FIGS. 1-4.

FIG. 6 illustrates a side view of the mouthpiece of FIGS. 1-5.

FIG. 7 illustrates a perspective view of the acrylic mouthpiece in the preferred embodiment of the game call.

FIG. 8 illustrates a second perspective view of the mouthpiece in the preferred embodiment of the game call.

### DETAILED DESCRIPTION OF FIGURES

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

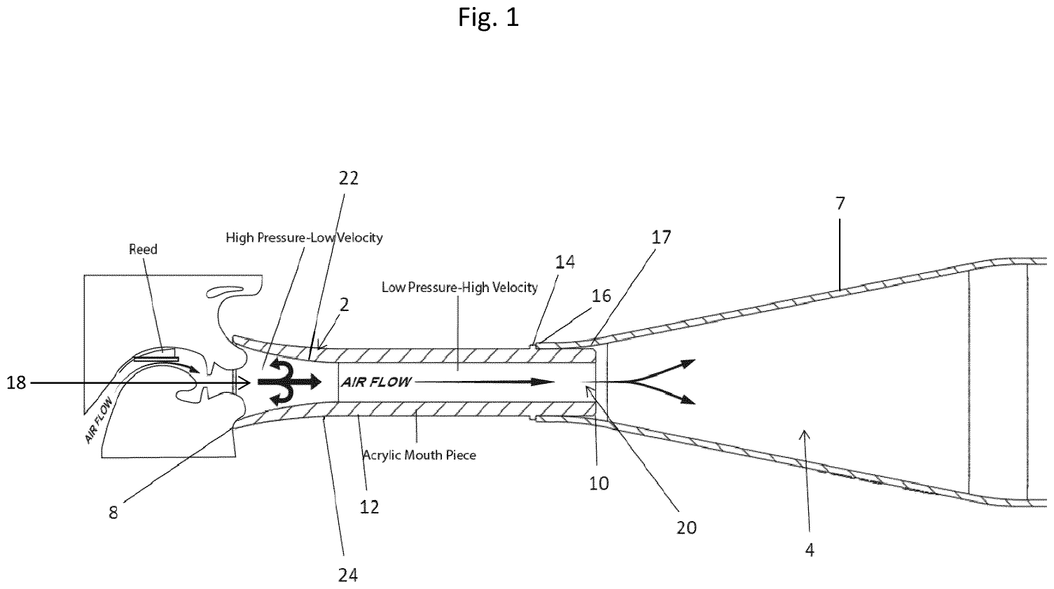

FIG. 1 illustrates a user blowing into an improved mouthpiece 2 attached to a bugle tube body 4. Together the mouthpiece and bugle tube body form what is referred to as a bugle tube. The user positions a reed in the user's mouth. The reed emits a sound when air is blown by the user across the reed. This air travels out of the user's mouth into the mouthpiece of the bugle tube. The air flows along the flowpath designated by arrows and labeled “AIRFLOW” in FIG. 1. The mouthpiece of the bugle tube has a first end 8 and a second end 10. The backpressure created by the tapered mouthpiece is shown by the circular arrows directed back toward the user's mouth in FIG. 1.

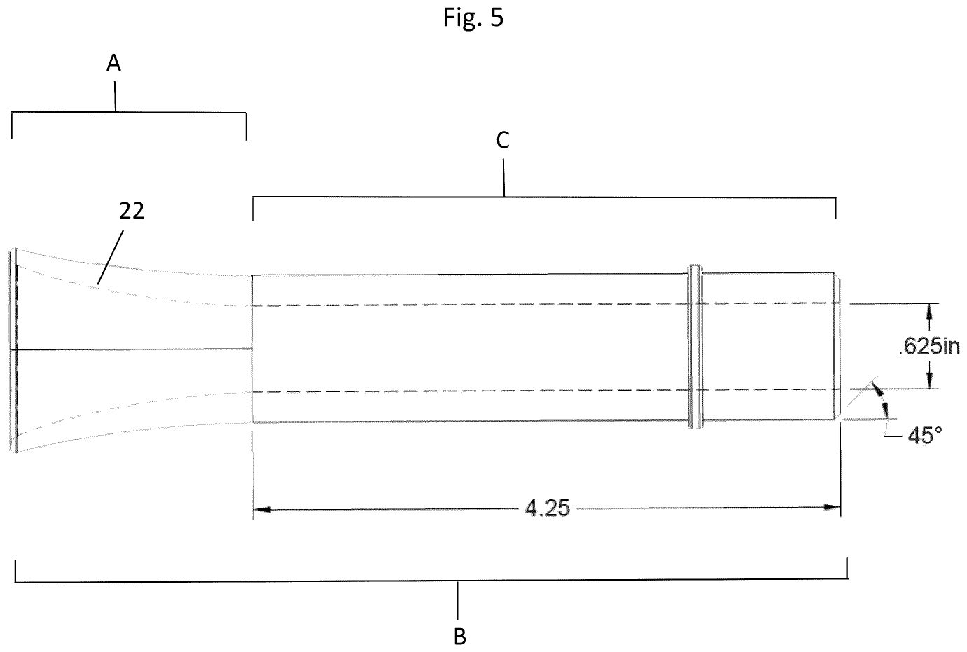

The first end 8 of the mouth piece defines a first end opening 18 that is configured for positioning on a user's mouth. The wall of the mouthpiece has an inner surface 22 and outer surface 24. The inner surface defines the flowpath of the mouthpiece. The mouthpiece is formed [5] such that the first end is tapered from a larger circumference to a narrower circumference as the mouthpiece extends from the first end. This tapering of the inner wall provides a back pressure on the air that is emitted from the user's mouth, facilitating improved sound and ease of use to the bugle tube. The tapered section (labeled as A in FIG. 5) has a length of approximately 1.75 inches in a preferred embodiment, with the full length of the mouthpiece (labeled as B in FIG. 5) extends approximately 4.25 inches to the second end of the mouthpiece.

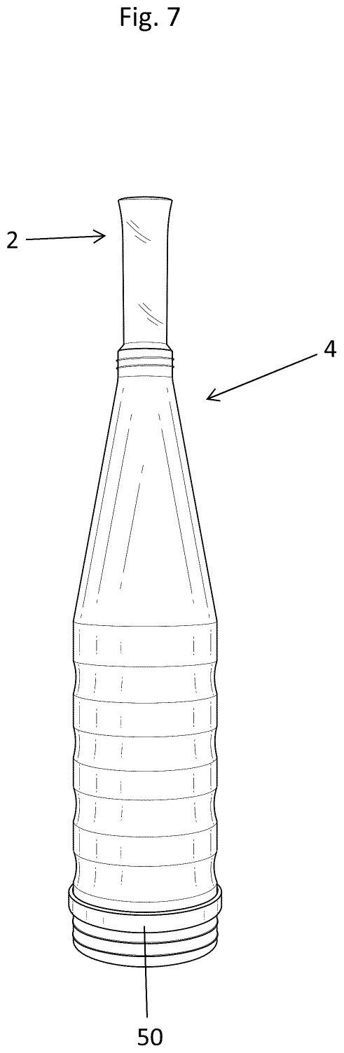

The bugle tube wall 7 defines a large resonance chamber 4 that increases the projection of sound created by the reed. Optionally a damper, such as a band (shown as 50 in FIG. 7). Alternatively, the mouthpiece can be utilized with an integral reed positioned externally to the mouthpiece, such as found in an external reed bugle, without varying from the depicted embodiment of the invention.

Preferably the external surface of the mouthpiece has a bugle wall seat that provides a seat for positioning of the bugle wall on the second end of the mouthpiece. The seat extends from the outer surface of the mouthpiece in FIGS. 1-7, although the seat can be provided as a recession in the outer surface that extends to the second end of the mouthpiece.

The first end 8 of the mouthpiece is shown with an opening larger then the diameter of the opening at the secured end of the mouthpiece of the body of the tube. The external surface of the mouthpiece has a ridge 14 that is created as a seat against which the resonance chamber first end 16 or bugle tube is positioned against. The narrow end 16 of the bugle tube seats against a portion 17 of the outer surface of the mouthpiece, providing a continuous airflow path through the mouthpiece and out the distal end of the bugle tube.

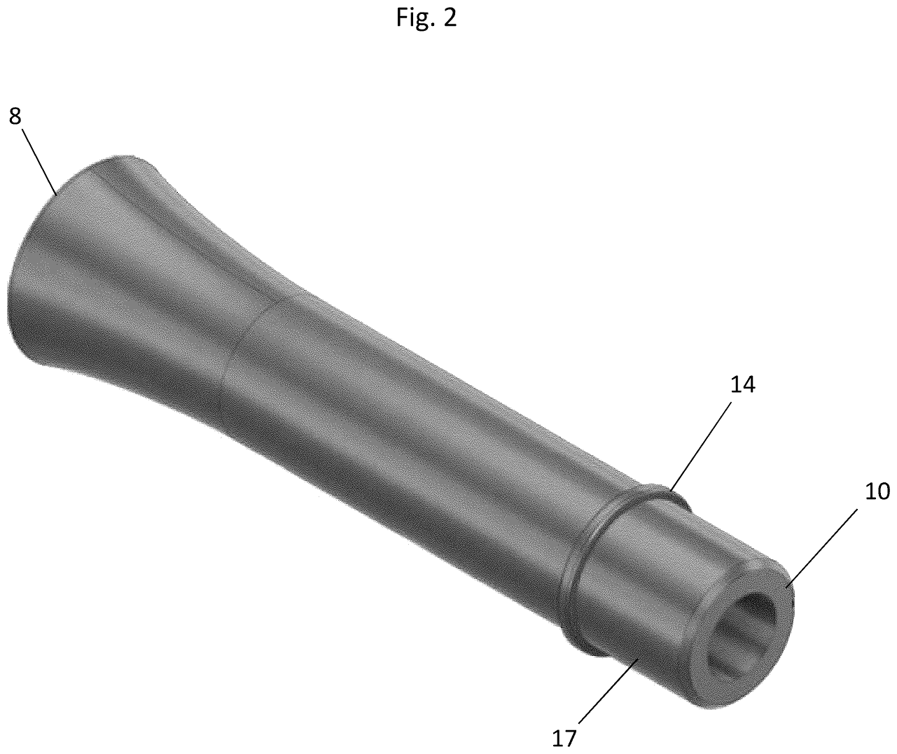

FIG. 2 illustrates a first perspective view of the mouthpiece of FIG. 1.

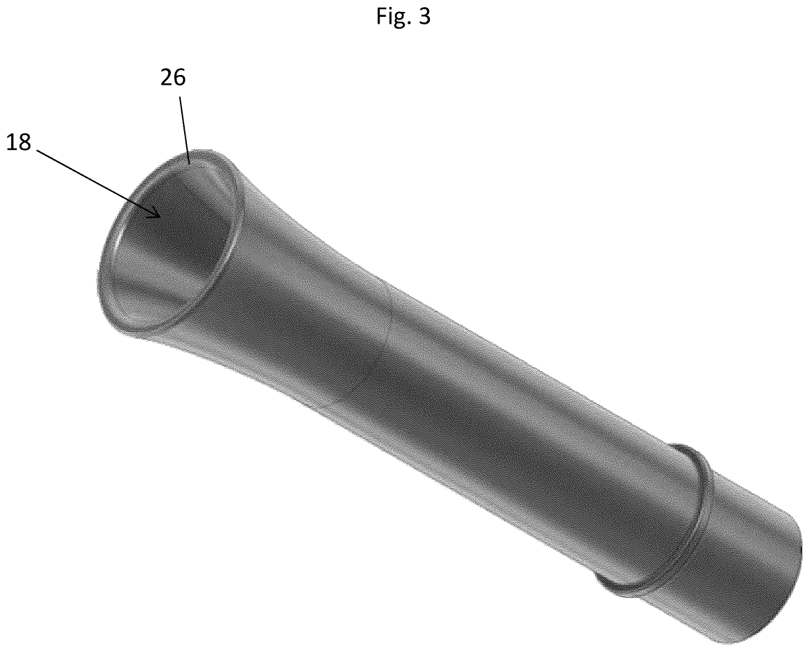

FIG. 3 illustrates a second perspective view of the mouthpiece of FIG. 1. The rim 26 of the first end of the mouthpiece is positioned at the user's mouth allowing the user to blow air across the reed and into the mouthpiece.

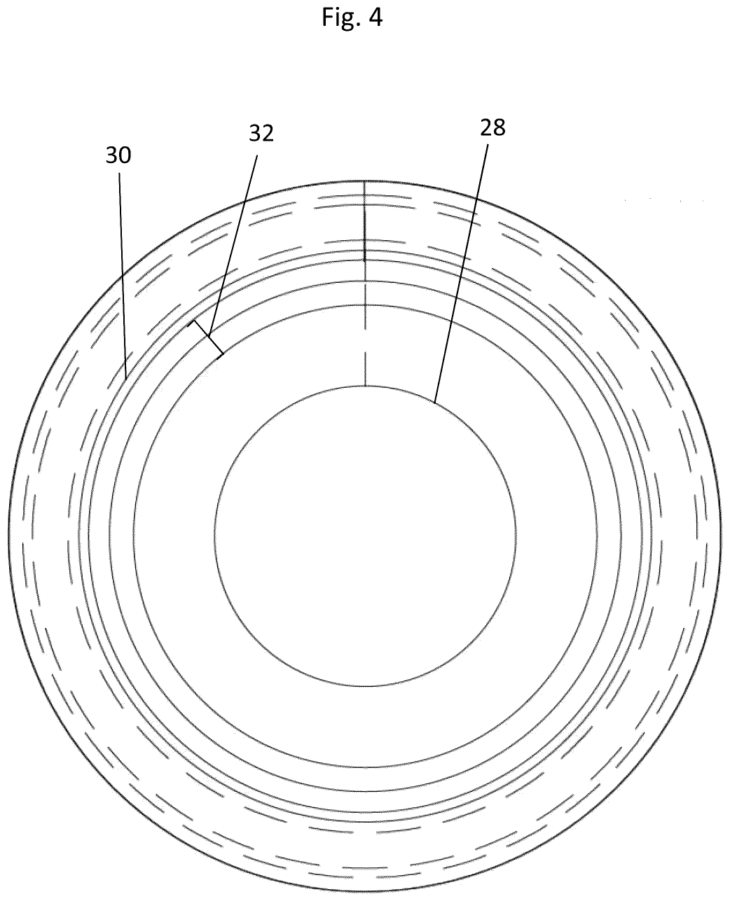

FIG. 4 illustrates a front view of the mouthpiece illustrating the wider circumference of the first end of the mouthpiece compared to the inner-diameter of the mouthpiece following the taper.

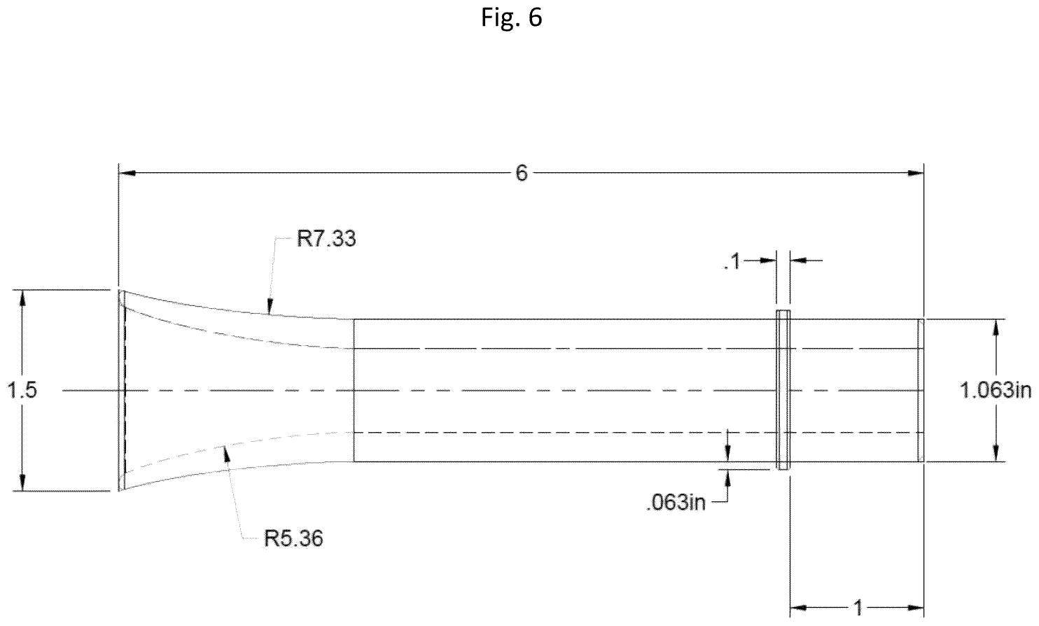

FIGS. 5 and 6 illustrate the measurements of the mouthpiece at different sections. The total length B of the mouthpiece in the depicted embodiment is 6 inches. The non-tapered section C of the mouthpiece extends for 4.25 inches, with the tapered section 22 extending A for 1.75 inches. While inches are depicted, similar rations can be utilized, such as In contrast, the inner-diameter of the non-tapered section is 0.625 inches. The reduction in diameter provides an increase in back pressure that provides an enhanced sound quality.

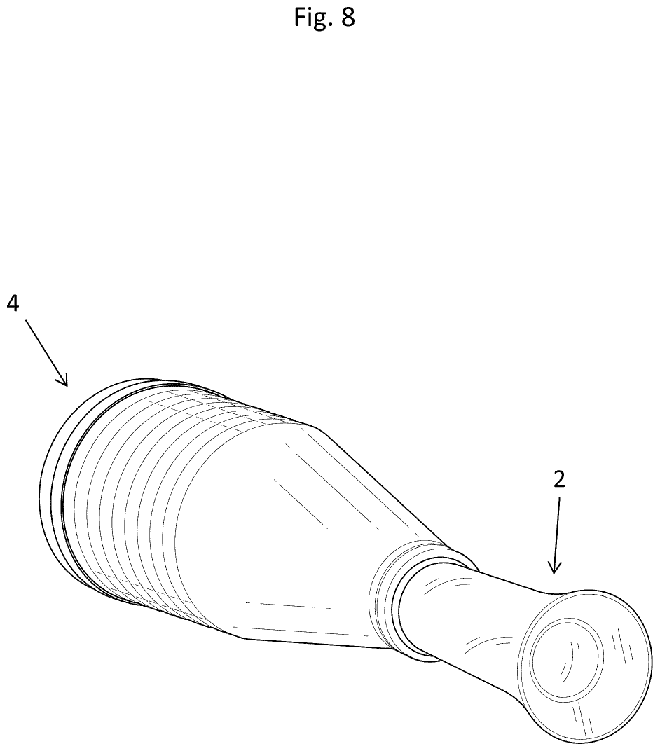

FIG. 7 illustrates a first perspective view of a mouthpiece and bugle tube body. The mouthpiece is constructed of at least partially translucent acrylic. The translucent acrylic provides a unique look to the bugle tube. FIG. 8 illustrates a second perspective view of the mouthpiece and tube looking at the first end of the mouthpiece. The bugle tube wall is preferably made of plastic, although alternate materials can be used such as metal.

What is claimed is:

1. An improved bugle tube for use with a reed comprising:
an elongate acrylic mouthpiece comprising a mouthpiece wall having a first end and a second end and a mouthpiece wall inner surface and a mouthpiece wall outer surface, wherein said first end defining a first mouthpiece end aperture and said second end defining a second mouthpiece end aperture, wherein said mouthpiece wall inner surface defining a flowpath from said first mouthpiece end aperture through said mouthpiece and out said second aperture, wherein said first mouthpiece end aperture having a greater circumference than said second mouthpiece end aperture, wherein said mouthpiece wall inner surface comprises a tapered section extending inward from said first mouthpiece end aperture to a cylindrical section and is configured to provide backpressure on air blown into said first end aperture, wherein said cylindrical section comprises a generally uniform circumference to said second mouthpiece end aperture;
wherein said wherein said elongate mouthpiece is formed of an acrylic,
a bugle wall connected to said second end of said mouthpiece, said bugle wall defining a resonance chamber, wherein said bugle wall comprises a bugle wall circumference greater than the circumference of said first mouthpiece end aperture.

2. The game call of claim 1 wherein the mouthpiece length is approximately 6 inches.

3. The game call of claim 2 wherein said taper extends for approximately 1.75 inches.

4. The game call of claim 2 wherein said outer diameter of said mouthpiece is 1.5 inches.

5. The game call of claim 1, wherein said mouthpiece comprises a bugle seat for positioning of said bugle wall, wherein said seat extending from an outer surface of said outer surface of said mouthpiece wall.

6. The game call of claim 5 wherein said bugle seat is approximately an inch from said second mouthpiece end.

7. The game call of claim 1 wherein said bugle wall comprises a plastic.

8. The game call of claim 1 wherein said tapered section extends from between 25% to 35% of the total length of said acrylic elongate mouth piece.

9. The game call of claim 1 wherein said tapered section extends from between 28 to 32% of the length of said acrylic elongate mouth piece.
